(19) United States
(12) Patent Application Publication
(10) Pub. No.: US 2010/0015955 A1
(43) Pub. Date: Jan. 21, 2010

(54) CALL MANAGEMENT BETWEEN COMMUNICATION DEVICES

(75) Inventors: Erik BACKLUND, Gantofta (SE); Andreas KRISTENSSON, Lund (SE); Par-Anders ARONSSON, Malmo (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(73) Assignee: SONY ERICSSON MOBILE COMMUNICATIONS AB, Lund (SE)

(21) Appl. No.: 12/175,546

(22) Filed: Jul. 18, 2008

(51) Int. Cl. H04M 3/42

(52) U.S. Cl. 455/414.1

(57) ABSTRACT

The invention relates to a method for managing communications between communication devices. The method comprise initiating a communication between a first and a second communication device, during which the second communication device may identify a third communication device, and provide the contact information of the third communication device to the first communication device. The first communication device receives the contact information and initiates communications with the third communication device.

### TECHNICAL FIELD

The present invention relates to the field of mobile communication devices and, in particularly, to management of calls between mobile communications devices. A method for adding a communication device to an ongoing communication and for transferring an ongoing communication from one communication device to another communication device is disclosed herein.

### BACKGROUND

Communication devices, such as mobile phones, play an important role in people's business and social life. The mobile phone offers a unique way of communicating with each other without actually having to meet face-to-face. However, if a group of people want to engage in a group conversation, with people joining and leaving the conversations as in a face-to-face conversation, this way of communicating do not work well. For example, two people, user A in location A and user B in location B, are having an voice conversation. A third person, user C, arrives at location B and wants to join the conversation between A and B. User C may either ask user B to turn on a ‘speaker mode’ on his mobile phone, which often has poor sound quality and the users need to stand close together to both engage in the conversation, or ask user B to relay information to and from user A, which is a slow and cumbersome way of having a conversation.

Therefore, finding a way to manage communication between users in such way that users may freely join (be added), hand over (transferring), and/or leave (terminating) an ongoing communication, using their own mobile phone, as they would do in a face-to-face group conversation would be very covet.

### SUMMARY OF THE INVENTION

With the above and following description in mind, then, an aspect of the present invention is to provide a method for managing communications between users, thus seeking to mitigate, alleviate, or eliminate one or more of the above-identified deficiencies in the art and disadvantages singly or in any combination.

A first aspect of the present invention relates to a method for managing communications between communication devices, comprising the steps of initiating a communication between a first and a second communication device, wherein during said communication, said second communication device identifies a third communication device, and provide contact information of said third communication device to said first communication device, said first communication device receive said contact information, and wherein said first communication device initiate communication with said third communication device.

The method may also comprise the steps wherein said second communication device acquires contact information of a third communication device, sending said acquired contact information to said first communication device.

The method may also comprise the steps wherein said second communication device request said contact information from said third communication device, wherein said third communication device send said contact information to said first communication device.

The method may also comprise the step wherein said request comprise contact information to said first communication device.

The method may also comprise the steps wherein the initiated communication between the first and second communication devices is performed by a first communication method, and the sending of the contact information is performed by a second communication method.

The method may also comprise the step wherein the initiated communication between the first and the second communication device are terminated after the first communication device has received said contact information.

The method may also comprise the steps wherein the said contact information is acquired by communication between said second and third communication device.

The method may also comprise the steps wherein the said contact information is acquired by communication between said second communication device and an internal database.

The method may also comprise the steps wherein the said contact information is acquired by communication between said second communication device and an external database.

The method may also comprise the steps wherein the said communication between said second and third communication device comprise the steps of, sending a request for contact information from said second communication device to said third communication device, and sending requested contact information from said third communication device to said second communication device.

A second aspect of the present invention relates to a communication device for managing communication with further communication devices, comprising, means for setting up communication with the further communication devices, means for identifying the further communication devices, means for requesting contact information from the further communication devices, and means for receiving and providing contact information of the further communication devices during communication with the further communication devices.

The communication device may further comprise means for communicating with an external database.

The communication device may further comprise means for communicating with an internal database.

The communication device may further comprise means for terminating communication with further communication devices.

A third aspect of the present invention relates to a communication system comprising communication devices in accordance to any combination of the features mentioned under the second aspect above.

Any of the features in the first, second, or third aspect of the present invention above may be combined in any way possible.

### BRIEF DESCRIPTION OF THE DRAWINGS

Further objects, features, and advantages of the present invention will appear from the following detailed description of some embodiments of the invention, wherein some embodiments of the invention will be described in more detail with reference to the accompanying drawings, in which:

FIG. 1 shows a mobile communication device, in this case a mobile phone, according to an embodiment of the present invention; and

FIG. 2 shows two communication devices engaged in call management of voice communication with each other, according to an embodiment of the present invention; and

FIG. 3 shows a group of communication devices engaged in call management of voice communications, according to an embodiment of the present invention; and

FIG. 4 an example of a display view in a mobile communication device during call management; and

FIG. 5 shows yet another group of communication devices engaged in call management of voice communication with each other, according to an embodiment of the present invention; and

FIG. 6 shows yet another shows a group of communication devices engaged in call management of voice communication with each other, according to an embodiment of the present invention; and

FIG. 7 shows a communication device connected via a wireless communication link to an external database.

FIG. 8 shows a group of communication devices engaged in call management of voice communications, according to another embodiment of the present invention.

### DETAILED DESCRIPTION

Embodiments of the present invention relate, in general, to the field of managing communication, or calls, between mobile communications devices. A preferred embodiment relates to a portable communication device, such as a mobile phone. However, it should be appreciated that the invention is as such equally applicable to electronic devices which do not include any radio communication capabilities. However, for the sake of clarity and simplicity, most embodiments outlined in this specification are related to mobile phones.

Embodiments of the present invention will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference signs refer to like elements throughout.

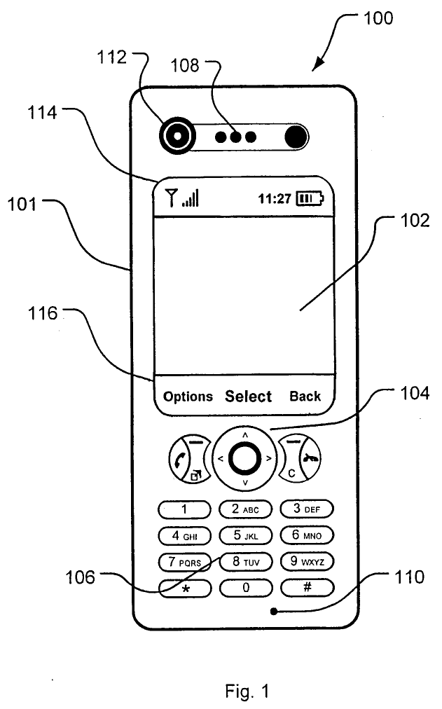

FIG. 1 show a mobile communication device 100, according to an embodiment of the present invention, comprising a casing 101, a display area 102 and means 104 for navigating among items (not shown) displayed in the display area. The display area 102 may comprise a status indication area 114 and one or more softkey bars 116. The status indication area 114 may for example include symbols for indicating battery status, reception quality, speaker on/off, present mode, time and date, etc. The status indication section is not in any way limited to include the symbols and the functions presented herein. The softkey bar 116 is operable using the navigation means 104 or, if using a touch sensitive screen, by tapping the softkey directly with a pen-like object, a finger, or other body part. The functions of the softkeys are not limited by the functions indicated in the figure. Neither are the placements of the softkey bar 116 and the status indication area 114 limited to be placed at the bottom and the top of the screen, as shown in the example. The navigation means 104 can be a set of buttons, a rotating input, a joystick, a touch pad, a multidirectional button, but can also be implemented using a touch sensitive display, wherein the displayed items directly can be tapped by a user for selection, or be voice activated via a headset or a built-in microphone. The mobile communication device 100 can also comprise other elements normally present in such a device, such as a keypad 106, a speaker 108, a microphone 110, a camera 112, a processor (not shown), a memory (not shown), one or more accelerometers (not shown), a vibration device (not shown), an AM/FM radio transmitter and receiver (not shown), a digital audio broadcast transmitter and receiver (not shown), etc.

One way of solving, or at least mitigate, the problems discussed in the background section is to manage the communication by using contact information of the party that wants to join the communication. In this way, users may, in a swift and easy way, both join and leave an ongoing communication. The following embodiments will in greater detail describe the process of how communications between communication devices may be managed using contact information.

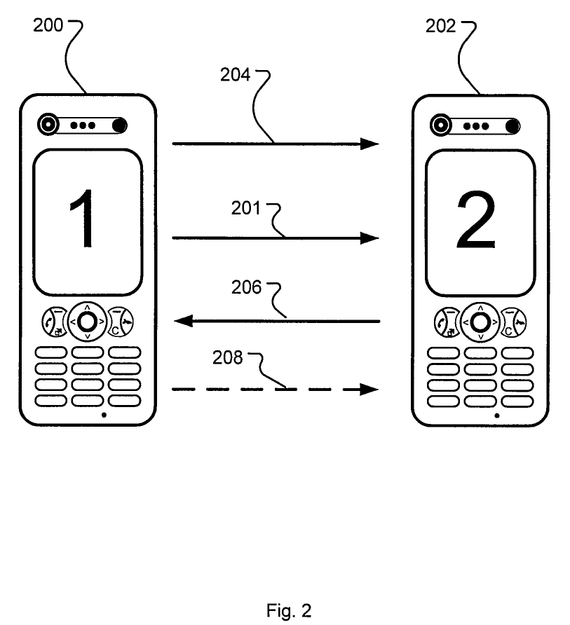

FIG. 2 shows an example describing how a communication device (user) may acquire contact information from another communication device (user). The first communication device 200, indicated in the figure by the number 1, identifies 201 a second communication device 202, indicated in the figure by the number 2, from which contact information is wanted. The identification of the second communication device may be done using some kind of wireless communication technique, e.g. Bluetooth, Short Message Service (SMS), Multimedia Message Service (MMS), Infrared (IR) communication, Near Field Communication (NFC), FM/AM radio, Wi-Fi, WLAN, laser light, visible light, acoustic energy, etc., or by the user of the first communication device himself, e.g. visually, orally, or some other bodily or mental communication. When the second communication device 202 has been identified 201, the first communication device may initiate communication with the second communication device by transmitting 204 a ‘request for contact information’ to the second communication device 202. The communication 204 of the request between the two devices may be performed in several different ways such as by using Bluetooth, Short Message Service (SMS), Multimedia Message Service (MMS), voice communication, Infrared (IR) communication, Near Field Communication (NFC), FM/AM radio, Wi-Fi, WLAN, laser light, visible light, acoustic energy, etc., or some other wireless communication technique. The second communication device 202 receives the ‘request for contact information’ sent by the first communication device, and responds to the request by transmitting its contact information 206 to the first communication device 200. The contact information may be in the form of a vCard, a telephone number, an e-mail address, a communication address, or some other identification which may be used to establish communication between the devices. The first communication device 200 receives the contact information transmitted 206 by the second communication device 202. Optionally (hence the jagged line), the first communication device may transmit 208 an acknowledgement that the first communication device has received the requested contact information from the first communication device. In this way the first device 200 has received information, the contact information, which may be used to establish a connection with the second communication device 202, i.e. information to manage the communication between the two communication devices.

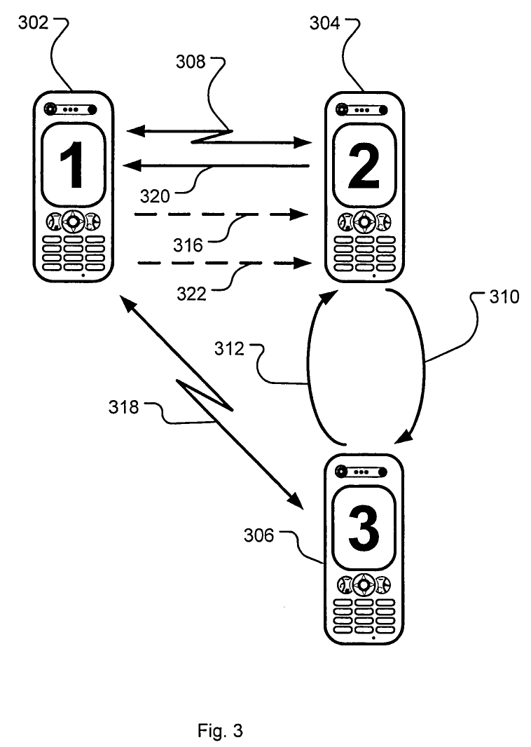

FIG. 3 shows an embodiment of the present invention. In this example two communication devices 302, 304, indicated with the numbers 1 and 2 in the figure, are engaged in voice communication 308 with each other (as indicated by the arrowed flash). A third communication device 306, indicated by the number 3 in the figure, is identified by the second communication device 304. The third communication device may either be added to the ongoing communication between the first and the second communication devices (compare with a three-party phone conversation), or the second communication device may transfer the ongoing communication between the first and the second communication devices to the third communication device. The second communication device 304 sends 310 a request for contact information to the third communication device 306 by some communication technique mentioned in conjunction with FIG. 2. The third communication device 306 acknowledges the request by sending 312 its contact information (such as the mobile telephone number) to the second communication device 304. The second communication device 304 sends (or forwards) the received contact information (coming from the third communication device) to the first communication device 320. In this way the first communication device is now able to manage the communication between the communication devices based on the received contact information.

If the third communication device is going to be added to the ongoing communication between the first and the second communication device, an acknowledge of received contact information 316 may optionally (hence jagged line) be sent to the second communication device 304. The first communication device, which manages the communication, establishes a communication 318 with the third communication device based on the received contact information to the third communication device.

If the ongoing communication between the first and the second communication devices is going to be transferred from the second communication device to the third communication device, a termination message/signal 322 may optionally (hence the jagged line) may be sent to the second communication device 304 before or after the communication 318 has been established (initiated and setup) between the first 302 and the third 306 communication device, thus terminating the communication between the first and the second communication device.

To clarify the management process described in conjunction with FIG. 3, a user example of how to manage a conversation between three users will now be described. Two users (first and second communication devices), in different geographical locations, are engaged in conversation with each other. A third user (third communication device) comes for instance in close proximity of one of the users (second communication device). The third user wants to join the conversation. The second user gets the third user's contact information (e.g. the third users mobile number), during the ongoing voice call with the first user, by for instance using near field communication (e.g. RF-ID) with the third communication device. The contact information is sent to the first user (e.g. by SMS) which manages the call. The first user receives the contact information, initiate and sets up a call with the third user, and adds the user to the ongoing voice conversation with the second user.

In another embodiment the second communication device may be managing the communication, thus eliminating the need to send the contact information to the first communication device.

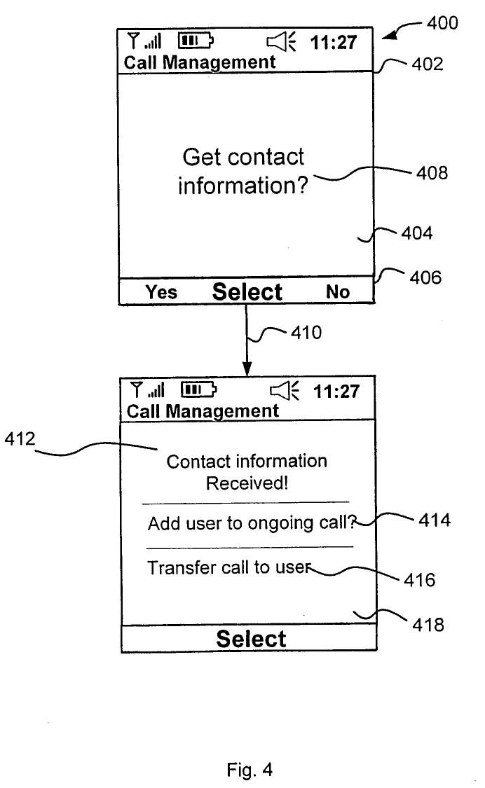

To further clarify the embodiment described in conjunction with FIG. 3, an example of a display view, of the second communication device, during the described procedure is presented in FIG. 4. FIG. 4 illustrates an example of a common display view in a communication device 400, comprising a general status indication section 402, a softkey bar 406 and a general display area 404. The general status indication section 402 may for instance include symbols for battery status, reception quality, speaker on/off, present mode, clock time, etc. The status indication section is not in any way limited to only include these symbols. Thus, other symbols in any shape, form or colour can occur. The softkey bar 406, situated at the bottom of the display view, is operable using the navigation means 104 mentioned in conjunction with FIG. 1. The functions of these softkeys are not limited by the functions indicated in the figure. The preferred function of the general display area 404, residing between the status indication section 402 at the top and the softkey bar 406 at the bottom, is to display information from running applications in the handheld communication apparatus.

During an ongoing communication between the first and the second communication devices the third communication device has been identified by the second communication. A message or an alert 408 is displayed in the general display area 404 of the second communication device. The message may, as shown in the FIG. 4, ask the user of the second communication device if the user wants to get the contact information from the identified third communication device or not 408. The user of the second communication device may then select the appropriate answer to the question by actuating the ‘Yes’ and ‘No’ option in the soft menu 406. If the user selects ‘Yes’ from the soft menu 406, a request for contact information is sent 410 to the identified third communication device. The third communication device sends the contact information to the second communication device which relays it to the first communication device which manages the communication. A message is then displayed in the general display area 418 of the first communication device 418, telling the user that the contact information is received 412. The user of the third communication device is then, as discussed in conjunction with FIG. 3, presented with two options to either add the user to the ongoing call or communication 414, or to transfer the ongoing call or communication to the user 416. The user may then select which of the two options the user wants to proceed with by actuating the navigation means and the ‘Selection’ option in the soft menu. The information is displayed in the communication devices display areas during the ongoing communication. In another embodiment the displayed information may be read to the user of the communication devices, e.g. cutting-in into the ongoing voice communication, and in yet another embodiment the displayed information may be projected visually or communicated via a tactile interface to the user.

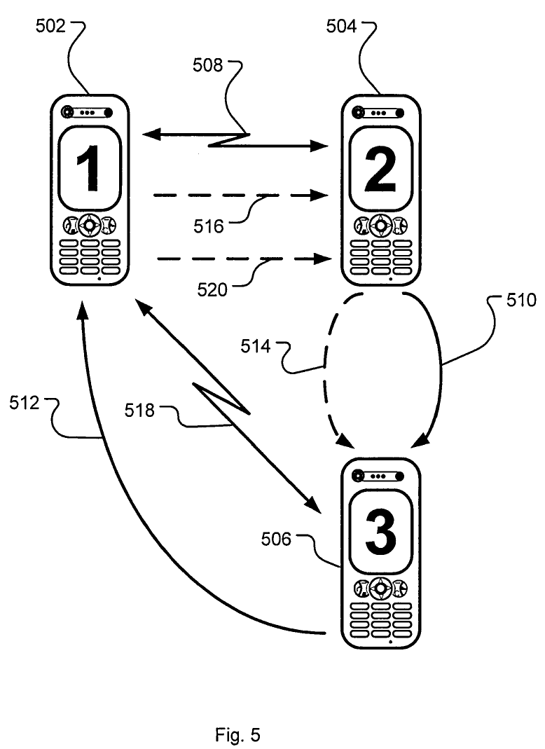

FIG. 5 shows an embodiment of the present invention. In this example two communication devices 502, 504 are engaged in voice communication 508 with each other. The second communication device 504 identifies a third communication device 506. In this embodiment the second communication device sends 510 the first communication device's contact information to the third communication device 506. The third communication device receives the contact information to the first communication device, and sends 512 its own (the third communication device's) contact information to the first communication device 502. The first communication device receives the third communication device's contact information and may, based on the contact information, establish a connection 518 with the third communication device. After (or just before) contact is established between the first and the third communication device, an acknowledgement of reception of the third communication device's contact information may optionally be sent 516 to the second communication device 504. This acknowledgement may then optionally be forwarded to the third communication device 514 from the second communication device. If the second communication device is not going to participant in the communication, the first communication device may before or after the establishing of communication with the third communication device, send 520 a termination message/signal to the second communication device, terminating the communication with the second communication device.

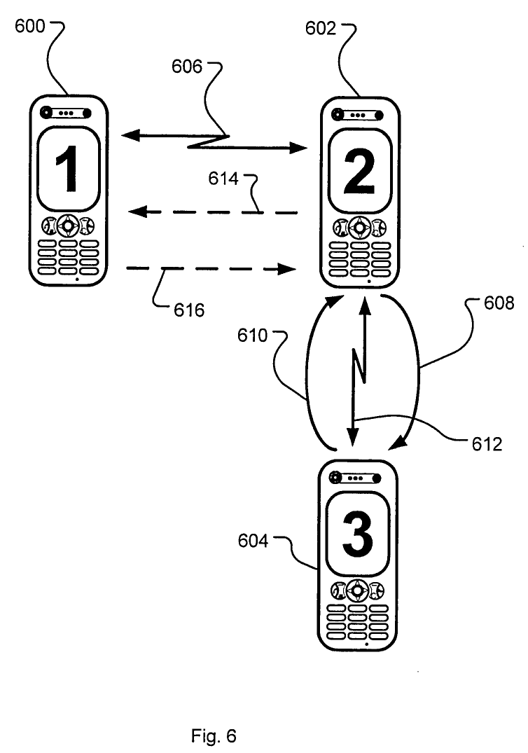

FIG. 6 shows an embodiment of the present invention. In this example two communication devices 600, 602 are engaged in voice communication 606 with each other (as indicated by the arrowed flash). The second communication device 602 identifies a third communication device 604. In this embodiment the second communication device sends a request for contact information 608 to the third communication device 604 which receives the request and sends its contact information 610 back to the second communication device 602. The second communication device establishes contact 612 with the third communication device based on the received contact information, and is in this way able to adding the third communication device to the ongoing communication between the first and the second communication device. Optionally, a permission to establish connection message/signal may be sent 614 to the first communication device before establishing communication with the third communication device. The user of the first communication device may in this way have control (or a saying) in who is allowed to join the ongoing communication or not. If the user of the first communication device approves a permission granted message/signal may be sent 616 to the second communication device before the third communication device is added to the ongoing communication. In this embodiment the second communication device manages the communication between the communication devices.

If the ongoing communication, between a multitude of communication devices, is of a sensitive nature an extra layer of security may be added by letting all participating parts in the communication approve every new connection of a communication device to the ongoing communication. In this way all parts in the ongoing communication will be aware of new parties capable of monitoring or participating in the communication.

In yet another embodiment, the second communication device may not be in the form of a mobile communication device belong to a user, but may instead be integrated into a conference communication unit, similar to the ones used in telephone conferences in conference rooms. In this embodiment the integrated second communication device manages all communication devices. Communication devices participating in a communication (e.g. a communication conference), must be identified (paired) by the integrated second communication device in the conference communication unit. The integrated second communication device may be instructed to manage all or some connecting communicating devices and/or the communication devices being in close proximity in a specific way. In this way a communication conference may be set up to involve only a specific group of communication device, thus giving only predetermined communication devices access and permission to join an conference, and in the same time effectively block all other communication devices trying to connect to the communication conference.

Acquiring contact information from an identified communication device may be done in several ways. One way is, as described in the embodiments above, by acquiring it directly from the communication device in question by some form of wireless communication technique, e.g. using a NFC technique such as RF-ID. However, this may in some cases only be possible if the communication device in question is in close proximity. Another way to retrieve contact information to a communication device which is not in close proximity is by using an internal database, such as the ‘phone book’ or ‘contacts’ in a mobile phone. For instance, if two users are engaged in communication with each other and they discover that they need the opinion of a third user, the first or the second user may then access the third user's contact information from their ‘contacts’ during the ongoing conversation, and use it to establish a communication with the third user. This will also be beneficial if the third user is in close proximity but the third user's communication device lacks the means (or the information) to transfer its contact information to the first or the second communication device.

The contact information may also be accessed from an external database, such as a phone and address service. If a user wants to acquire another user's contact information, the user may connect to the Internet and search, locate, and download needed contact information. Some kind of identification may be needed to access and download a user's contact information. In one embodiment a user may take a photo of a user which may be uploaded to a database performing face recognition on the photo, and sends back associated contact information (e.g. telephone number of the person(s) in the photo).

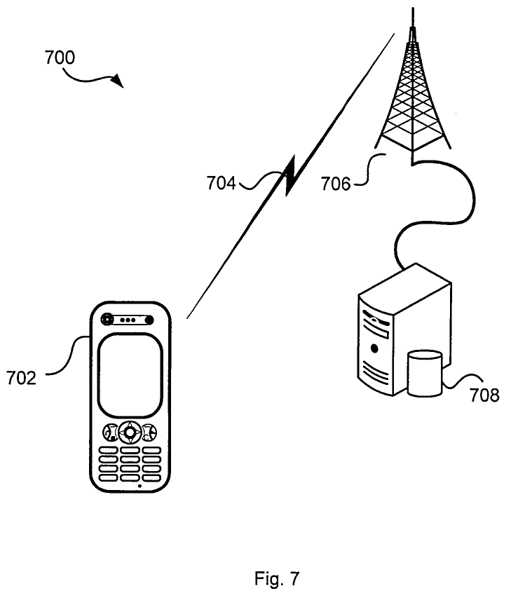

FIG. 7 shows an embodiment where a communication device 702 communicates wirelessly 704 with a wireless communication system 706, comprising for instance an antenna and a base station. The base station may be in contact with a database 708 running database applications capable of identifying and extracting information from received data (e.g. face recognition), associate the data with contact information, and send the contact information to a communication device. The mobile communication device 702 may also be connected directly to the database by wire.

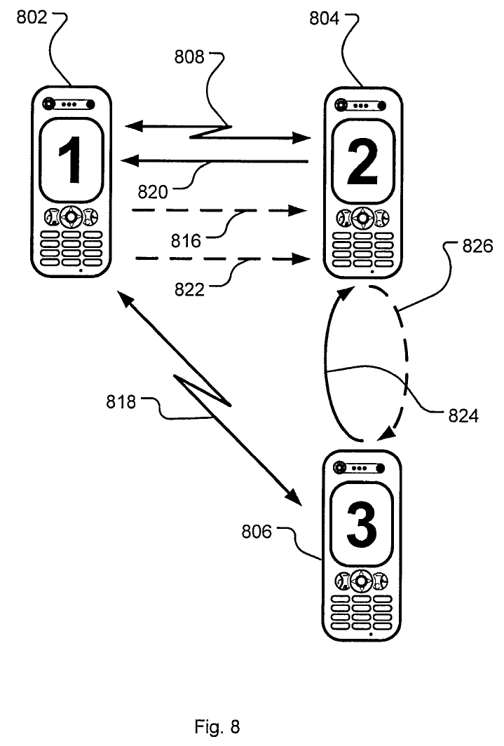

FIG. 8 shows an alternative embodiment to the embodiment presented in conjunction with FIG. 3. A first 802 and a second 804 communication device is engaged in a communication 808. A third communication device 806 sends 824 its contact information to the second communication device 804 by some communication technique mentioned in conjunction with FIG. 2. The second communication device 804 may optionally (hence the jagged line) send an acknowledgement signal/message 826 to indicate that the third communication device's 806 contact information was received. The second communication device 804 sends (or forwards) the received contact information (coming from the third communication device) to the first communication device 820. In this way the first communication device is now able to manage the communication between the communication devices based on the received contact information. If the third communication device is going to be added to the ongoing communication between the first and the second communication device, an acknowledge of received contact information 816 may optionally (hence jagged line) be sent to the second communication device 804. The acknowledgement of received contact information coming from the first communication device may optionally be forwarded to the third communication device 826. The first communication device, which manages the communication, establishes a communication 818 with the third communication device based on the received contact information to the third communication device. If the ongoing communication between the first and the second communication devices is going to be transferred from the second communication device to the third communication device, a termination message/signal 822 may optionally (hence the jagged line) may be sent to the second communication device 804 before or after the communication 818 has been established (initiated and setup) between the first 802 and the third 806 communication device, thus terminating the communication between the first and the second communication device. The termination message/signal coming from the first communication device may optionally be forwarded to the third communication device 826.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms used herein should be interpreted as having a meaning that is consistent with their meaning in the context of this specification and the relevant art and will not be interpreted in an idealized or overly formal sense unless expressly so defined herein.

The foregoing has described the principles, preferred embodiments and modes of operation of the present invention. However, the invention should be regarded as illustrative rather than restrictive, and not as being limited to the particular embodiments discussed above. The different features of the various embodiments of the invention can be combined in other combinations than those explicitly described. It should therefore be appreciated that variations may be made in those embodiments by those skilled in the art without departing from the scope of the present invention as defined by the following claims.

1. A method for managing communications between communication devices, comprising the steps of;
initiating a communication between a first and a second communication device, wherein during said communication
said second communication device identifies a third communication device, and provide contact information of said third communication device to said first communication device,
said first communication device receive said contact information; and
wherein said first communication device initiate communication with said third communication device.

2. The method according to claim 1, wherein said second communication device acquires contact information of a third communication device, sending said acquired contact information to said first communication device.

3. The method according to claim 1, wherein said second communication device request said contact information from said third communication device, wherein said third communication device send said contact information to said first communication device.

4. The method according to claim 4, wherein said request comprise contact information to said first communication device.

5. The method according to claim 1, where the initiated communication between the first and second communication devices is performed by a first communication method, and the sending of the contact information is performed by a second communication method.

6. The method according to claim 1, wherein the initiated communication between the first and the second communication device are terminated after the first communication device has received said contact information.

7. The method according to claim 1, wherein said contact information is acquired by communication between said second and third communication device.

8. The method according to claim 1, wherein said contact information is acquired by communication between said second communication device and an internal database.

9. The method according to claim 1, wherein said contact information is acquired by communication between said second communication device and an external database.

10. The method according to claim 1, wherein said communication between said second and third communication device comprise the steps of:
sending a request for contact information from said second communication device to said third communication device; and
sending requested contact information from said third communication device to said second communication device.

11. A communication device for managing communication with further communication devices, comprising;
means for setting up communication with the further communication devices;
means for identifying the further communication devices;
means for requesting contact information from the further communication devices; and
means for receiving and providing contact information of the further communication devices during communication with the further communication devices.

12. The communication device in claim 11, further comprise means for communicating with an external database.

13. The communication device in claim 11, further comprise means for communicating with an internal database.

14. The communication device in claim 11, further comprise means for terminating communication with further communication devices.

15. A communication system comprising communication devices in accordance to claim 11.
